(19) United States
(12) Patent Application Publication
(10) Pub. No.: US 2019/0013017 A1
(43) Pub. Date: Jan. 10, 2019

(54) METHOD, APPARATUS AND SYSTEM FOR PROCESSING TASK USING CHATBOT

(71) Applicant: SAMSUNG SDS CO., LTD., Seoul (KR)

(72) Inventors: Han Hoon KANG, Seoul (KR); Seul Gi KANG, Seoul (KR); Jae Young YANG, Seoul (KR)

(73) Assignee: SAMSUNG SDS CO., LTD., Seoul (KR)

(21) Appl. No.: 16/026,690

(22) Filed: Jul. 3, 2018

(30) Foreign Application Priority Data
Jul. 4, 2017 (KR) 10-2017-0084785

(51) Int. Cl. G10L 15/18; G06N 99/00; G10L 15/22; G10L 25/51; G10L 15/14

(52) U.S. Cl. CPC G10L 15/1815; G06N 99/005; G10L 2015/223; G10L 25/51; G10L 15/14; G10L 15/22

(57) ABSTRACT

Provided is a task processing method performed by a task processing apparatus. The task processing method includes detecting a second user intent different from a first user intent based on an utterance of a user while a first dialogue task including a first dialogue processing process corresponding to the first user intent is being executed, determining whether to initiate execution of a second dialogue task including a second dialogue processing process corresponding to the second user intent based on the detection of the second user intent and generating a response sentence responding to the utterance based on the determination of the initiation of the execution of the second dialogue task.

This application claims the benefit of Korean Patent Application No. 10-2017-0084785, filed on Jul. 4, 2017, in the Korean Intellectual Property Office, the disclosure of which is incorporated herein by reference in its entirety.

### BACKGROUND

### 1. Field of the Disclosure

The present disclosure relates to a method, apparatus, and system for processing a task using a chatbot, and more particularly, to a task processing method used for smooth dialogue task progression when, during a dialogue task between a user and a chatbot, another user intent irrelevant to the dialogue task is detected from the user's utterance and an apparatus and system for performing the same method.

### 2. Description of the Related Art

Many companies operate call centers as part of their customer service, and the sizes of the call centers also increase as their businesses expand. In addition, a system is being built to complement a call center in various forms by using IT technology. An example of such a system is an automatic response service (ARS) system.

In recent years, along with the maturation of artificial intelligence and big data technology, an intelligent ARS system has been built to replace call center counselors with intelligent agents such as a chatbot. In the intelligent ARS system, a speech uttered by a user is converted into a text-based utterance sentence, and an intelligent agent analyzes the utterance to understand the user's query and automatically provide a response to the query.

On the other hand, customers who use call centers may occasionally ask questions about other topics during a consultation. In such a case, a call counselor may understand a customer's intent and respond appropriately to the situation. In other words, even if the subject is suddenly changed, the call counselor may actively cope with the change and continue a dialogue about the changed subject or may listen to the customer in order to accurately grasp the customer's intent despite the call counselor's turn.

However, in the intelligent ARS system, it is very difficult for the intelligent agent to accurately grasp the customer's intent to determine whether to continue the ongoing consultation or to consult on a new topic. It will be appreciated that the intelligent agent can leave the above determinations to the customer by asking the customer a query about whether to conduct a consultation on a new topic. However, when such queries are frequently repeated, this may cause a reduction in satisfaction of customers who use the intelligent ARS system.

Accordingly, when a new utterance intent is detected, there is a need for a method of accurately determining whether to start a dialogue about a new subject or whether to continue a dialogue about the previous subject.

### SUMMARY

Aspects of the present disclosure provide a task processing method, apparatus, and system for performing smooth dialogue processing when a second user intent is detected from a user's utterance while a dialogue task for a first user intent is being executed.

Aspects of the present disclosure also provide a task processing method, apparatus, and system for accurately determining whether to initiate a dialogue task for a second user intent different from the first user intent when the second user intent is detected from the user's utterance.

It should be noted that objects of the present disclosure are not limited to the above-described objects, and other objects of the present disclosure will be apparent to those skilled in the art from the following descriptions.

According to an aspect of the present disclosure, there is provided is a task processing method performed by a task processing apparatus. The task processing method comprises detecting a second user intent different from a first user intent based on an utterance of a user while a first dialogue task comprising a first dialogue processing process corresponding to the first user intent is being executed, determining whether to initiate execution of a second dialogue task comprising a second dialogue processing process corresponding to the second user intent based on the detection of the second user intent and generating a response sentence responding to the utterance based on the determination of the initiation of the execution of the second dialogue task.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram of an intelligent automatic response service (ARS) system according to an embodiment of the present disclosure;

FIG. 2 is a block diagram showing a service provision server which is an element of the intelligent ARS system;

FIGS. 3A to 3C show an example of a consultation dialogue between a user and an intelligent agent;

FIG. 4 is a block diagram showing a task processing apparatus according to another embodiment of the present disclosure;

FIGS. 5A and 5B show an example of a dialogue act that may be referenced in some embodiments of the present disclosure;

FIG. 6 shows an example of a user intent category that may be referenced in some embodiments of the present disclosure;

FIG. 7 is a hardware block diagram of a task processing apparatus according to still another embodiment of the present disclosure;

FIG. 8 is a flowchart of a task processing method according to still another embodiment of the present disclosure;

FIG. 9 is an example detailed flowchart of a user intent extracting step S300 shown in FIG. 8;

FIG. 10 is a first example detailed flowchart of a second dialogue task execution determining step S500 shown in FIG. 8;

FIG. 11 is a second example detailed flowchart of the second dialogue task execution determining step S500 shown in FIG. 8;

FIGS. 12A and 12B show an example of a sentiment word dictionary that may be referenced in some embodiments of the present disclosure;

FIG. 13 is a third example detailed flowchart of the second dialogue task execution determining step S500 shown in FIG. 8; and

FIGS. 14 and 15 show an example of a dialogue model that may be referenced in some embodiments of the present disclosure.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Like numbers refer to like elements throughout.

Unless otherwise defined, all terms including technical and scientific terms used herein have the same meaning as commonly understood by one of ordinary skill in the art to which this disclosure belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Prior to the description of this specification, some terms used in this specification will be defined.

In this specification, a dialogue act (or speech act) refers to a user's general utterance intent implied in an utterance. For example, the type of dialogue act may include, but is not limited to, a request dialogue act requesting processing of an action, a notification dialogue act providing information, a question dialogue act requesting information, and the like. However, there may be various dialogue act classification methods.

In this specification, a user intent refers to a user's detailed utterance intent included in an utterance. That is, the user intent is different from the above-described dialogue act in that the user intent is a specific utterance objective that a user intends to achieve through the utterance. It should be noted that the user intent may be used interchangeably with, for example, a subject, a topic, a main act, and the like, but may refer to the same object.

In this specification, a dialogue task refers to a series of dialogue processing processes performed to achieve the user intent. For example, when the user intent included in the utterance is “application for on-site service,” a dialogue task for “application for on-site service” may refer to a dialogue processing process that an intelligent agent has performed until the application for the on-site service is completed.

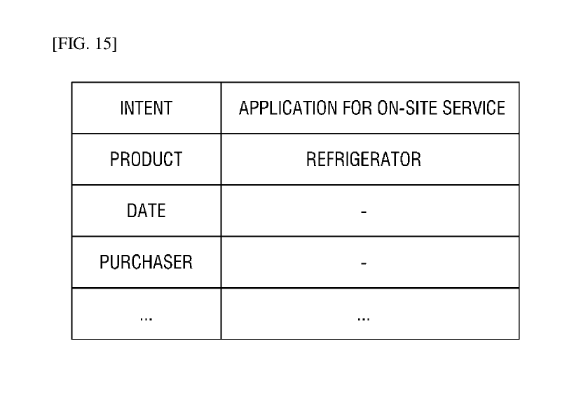

In this specification, a dialogue model refers to a model that the intelligent agent uses in order to process the dialogue task. Examples of the dialogue model may include a slot-filling-based dialogue frame, a finite-state-management-based dialogue model, a dialogue-plan-based dialogue model, etc. Examples of the slot-filling-based dialogue frame and the finite-state-management-based dialogue model are shown in FIGS. 14 and 15.

Hereinafter, some embodiments of the present disclosure will be described in detail with reference to the accompanying drawings.

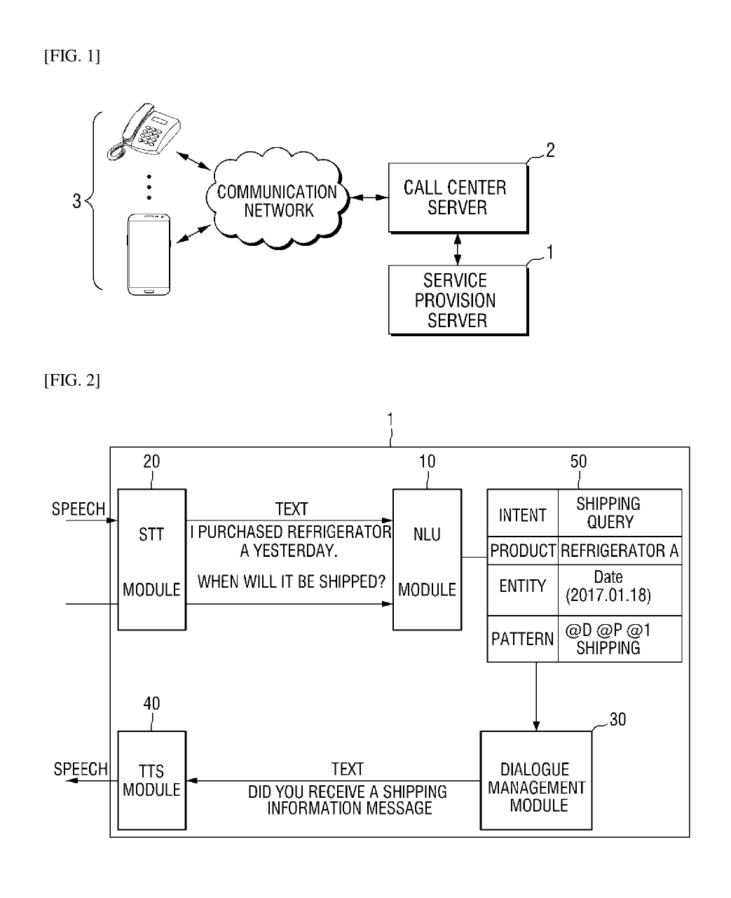

FIG. 1 shows an intelligent automatic response service (ARS) system according to an embodiment of the present disclosure.

The intelligent ARS system refers to a system that provides an automatic response service for a user's query by means of an intelligent agent such as a chatbot. In the intelligent ARS system shown in FIG. 1, as an example, the intelligent agent wholly replaces call counselors. However, the intelligent ARS system may be implemented such that some agents assist the intelligent agent to smoothly provide the response service.

In this embodiment, the intelligent ARS system may be configured to include a call center server 2, a user terminal 3, and a service provision server 1. However, it should be appreciated that this is merely an example embodiment for achieving the objects of the present disclosure and some elements may be added to, or deleted from, the configuration as needed. Also, elements of the intelligent ARS system shown in FIG. 1 indicate functional elements that are functionally distinct from one another. It should be noted that at least one of the elements may be integrated with another element in an actual physical environment.

In this embodiment, the user terminal 3 is a terminal that a user uses in order to receive the automatic response service. For example, the user may call the call center server 2 through the user terminal 3 to utter a query by voice and may receive a response provided by the service provision server 1 by voice.

The user terminal 3, which is a device equipped with voice call means, may include a mobile communication terminal including a smartphone, wired/wireless phones, etc. However, the present disclosure is not limited thereto, and the user terminal 3 may include any kind of device equipped with voice call means.

In this embodiment, the call center server 2 refers to a server apparatus that provides a voice call function for a plurality of user terminals 3. The call center server 2 performs voice call connections to the plurality of user terminals 3 and delivers speech data indicating the query uttered by the user during the voice call to the service provision server 1. Also, the call center server 2 provides, to the user terminal 3, speech data that is provided by the service provision and that indicates a response to the query.

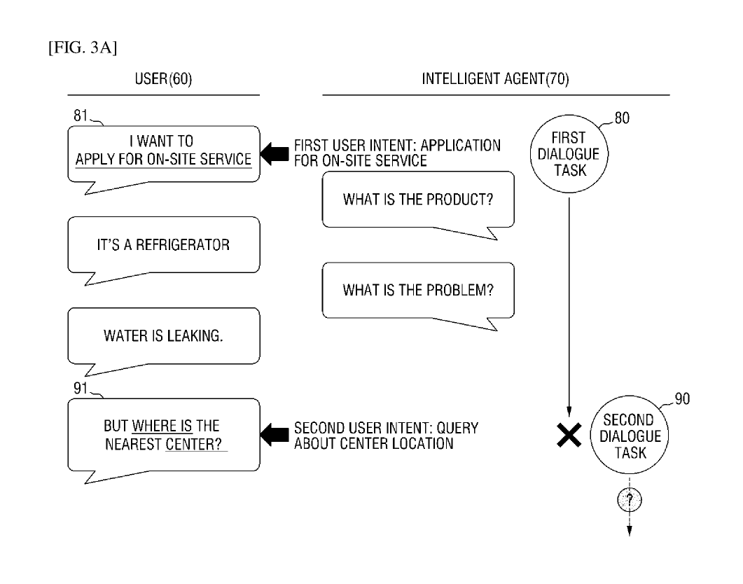

In this embodiment, the service provision server 1 is a computing device that provides an automatic response service to the user. Here, the computing apparatus may be a notebook, a desktop, a laptop, or the like. However, the present disclosure is not limited thereto, and the computing apparatus may include any kind of device equipped with computing means and communication means. In this case, the service provision server 1 may be implemented as a high-performance server computing apparatus in order to smoothly provide the service. In FIG. 1, the service provision server 1 is shown as being a single computing apparatus. In some embodiments, however, the service provision server 1 may be implemented as a system including a plurality of computing apparatuses. Detailed functions of the service provision server 1 will be described below with reference to FIG. 2.

In this embodiment, the user terminal 3 and the call center server 2 may perform a voice call over a network. Here, the network may be configured without regard to its communication aspect such as wired and wireless and may include various communication networks such as a wired or wireless public telephone network, a personal area network (PAN), a local area network (LAN), a metropolitan area network (MAN), and a wide area network (WAN).

The intelligent ARS system according to an embodiment of the present disclosure has been described with reference to FIG. 1. Subsequently, the configuration and operation of the service provision server 1 providing an intelligent automatic response service will be described with reference to FIG. 2.

FIG. 2 is a block diagram showing a service provision server 1 according to another embodiment of the present disclosure.

Referring to FIG. 2, for example, when a user's question is input as speech data “I purchased refrigerator A yesterday. When it will be shipped?” the service provision server 1 may provide speech data “Did you receive a shipping information message?” in response to the input.

In order to provide such an intelligent automatic response service, the service provision server 1 may be configured to include a speech-to-text (STT) module 20, a natural language understanding (NLU) module 10, a dialogue management module 30, and a text-to-speech (TTS) module 40. However, only elements related to the embodiment of the present disclosure are shown in FIG. 2. Accordingly, it is to be understood by those skilled in the art that general-purpose elements other than the elements shown in FIG. 2 may be further included. Also, the elements of the service provision server 1 shown in FIG. 2 indicate functional elements that are functionally distinct from one another. At least one of the elements may be integrated with another element in an actual physical environment, and the elements may be implemented as independent devices. Each element will be described below.

The STT module 20 recognizes a speech uttered by a user and converts the speech into a text-based utterance. To this end, the STT module 20 may utilize at least one speech recognition algorithm well known in the art. An example of converting a user's speech related to a shipping query into a text-based utterance is shown in FIG. 2.

The NLU module 10 analyzes the text-based utterance and grasps details uttered by the user. To this end, the NLU module 10 may perform natural language processing such as language preprocessing, morphological and syntactic analysis, and dialogue act analysis.

The dialogue management module 30 generates a response sentence suitable for situation awareness on the basis of a dialogue frame 50 generated by the NLU module 10. To this end, the dialogue management module 30 may include an intelligent agent such as a chatbot.

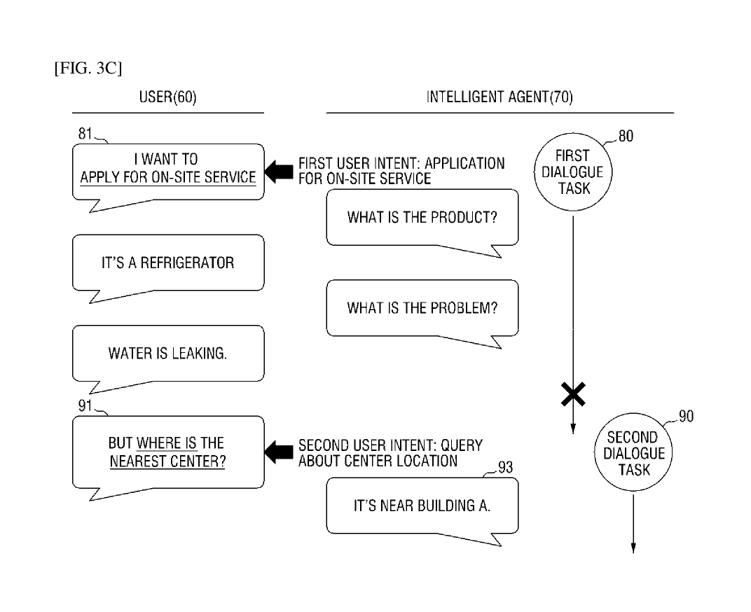

According to an embodiment of the present disclosure, while a first dialogue task corresponding to a first user intent is being executed, a second user intent different from the first user intent may be detected from the user's utterance. In this case, the NLU module 10 and/or the dialogue management module 30 may determine whether to initiate a second dialogue task corresponding to the second user intent and may manage the first dialogue task and the second dialogue task. Only in this embodiment, the NLU module 10 and/or the dialogue management module 30 may be collectively referred to as a task processing module, and a computing apparatus equipped with the task processing module may be referred to as a dialogue processing device 100. The task processing device 100 will be described in detail below with reference to FIGS. 4 to 7.

The TTS module 40 converts a text-based response sentence into speech data. To this end, the TTS module 40 may utilize at least one voice synthesis algorithm well known in the art. An example of converting a response sentence into speech data for checking whether a shipping information message is received is shown in FIG. 2.

The service provision server 1 according to an embodiment of the present disclosure has been described with reference to FIG. 2. Subsequently, for ease of understanding, an example will be described in which when another user intent may be detected from an utterance of a user who uses an intelligent ARS system, the detection is processed.

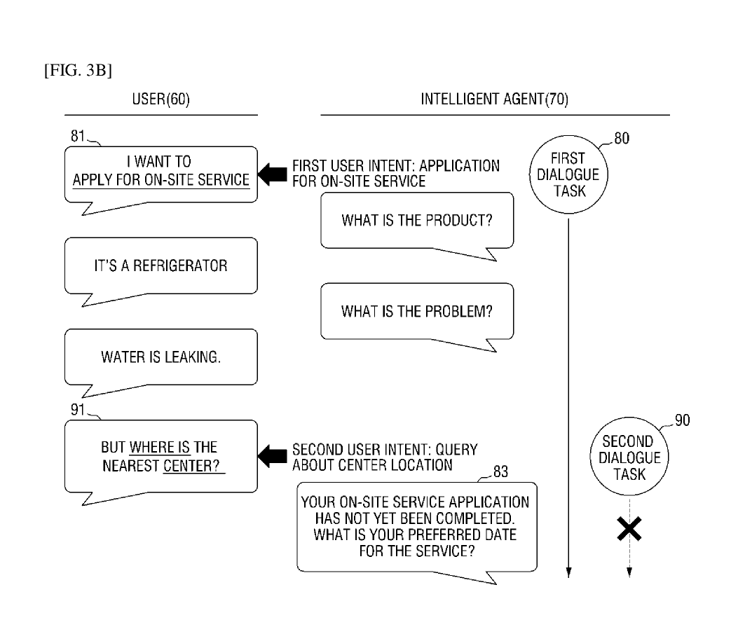

FIGS. 3A to 3C show an example of a consulting dialogue between a user who uses the intelligent ARS system and an intelligent agent 70 that uses an automatic response service.

Referring to FIG. 3A, when an utterance 81 “I want to apply for on-site service.” is input from the user 60, the intelligent agent 70 may grasp, from the utterance 81, that a first user intent is a request for applying for on-site service and may initiate a first dialogue task 70 indicating a dialogue processing process for the on-site service application request. For example, the intelligent agent 70 may generate a response sentence including a query about a product type, a product state, or the like in order to complete the first dialogue task 80.

Before the on-site service application request is completed through the first dialogue task 70, an utterance including another user intent different from “on-site service application request” may be input from the user 60. In FIG. 3A, an utterance 81 for asking about the location of a nearby service center is shown as an example. As an example, an utterance including another user intent different from the previous one may be input due to various reasons, for example, when the user 60 mistakenly thinks that the application for the on-site service has already been completed or when the user 60 thinks that he/she is going to the service center directly without waiting for a warranty service manager.

In such a situation, the intelligent agent 70 may determine whether to ignore the input utterance and continue to execute the first dialogue task 80 or to pause or stop the execution of the first dialogue task 80 to initiate a second dialogue task 90 corresponding to a second user intent

In this case, as shown in FIG. 3B, the intelligent agent 70 may provide a response sentence 83 for ignoring or pausing the processing of the utterance 91 and for completing the first dialogue task 80.

Alternatively, as shown in FIG. 3C, the intelligent agent 70 may stop or pause the first dialogue task 80 and may initiate the second dialogue task 90.

Alternatively, the intelligent agent 70 may generate a response sentence including a query about which of the first dialogue task 80 and the second dialogue task 90 is to be executed and may execute any one of the dialogue tasks 80 and 90 according to selection of the user 60.

Some embodiments of the present disclosure, which will be described below, relate to a method and apparatus for determining operation of the intelligent agent 70 in consideration of a user's utterance intent.

The configuration and operation of a task processing apparatus 100 according to still another embodiment will be described below with reference to FIGS. 4 to 9.

FIG. 4 is a block diagram showing a task processing apparatus 100 according to still another embodiment of the present disclosure.

Referring to FIG. 4, the task processing apparatus 100 may include an utterance data input unit 110, a natural language processing unit 120, a user intent extraction unit 130, a dialogue task switching determination unit 140, a dialogue task management unit 150, and a dialogue task processing unit 160. However, only elements related to the embodiment of the present disclosure are shown in FIG. 4. Accordingly, it is to be understood by those skilled in the art that general-purpose elements other than the elements shown in FIG. 4 may be further included. Further, the elements of the task processing apparatus 100 shown in FIG. 4 indicate functional elements that are classified by function, and it should be noted that at least one element may be given in combination form in a real physical environment. Each element of the task processing apparatus 100 will be described below.

The utterance data input unit 110 receives utterance data indicating data uttered by a user. Here, the utterance data may include, for example, speech data uttered by a user, a text-based utterance, etc.

The natural language processing unit 120 may perform natural language processing, such as morphological analysis, dialogue act analysis, syntax analysis, named entity recognition (NER), and sentiment analysis, on the utterance data input to the utterance data input unit 110. To this end, the natural language processing unit 120 may use at least one natural language processing algorithm well known in the art, and any algorithm may be used for the natural language processing algorithm.

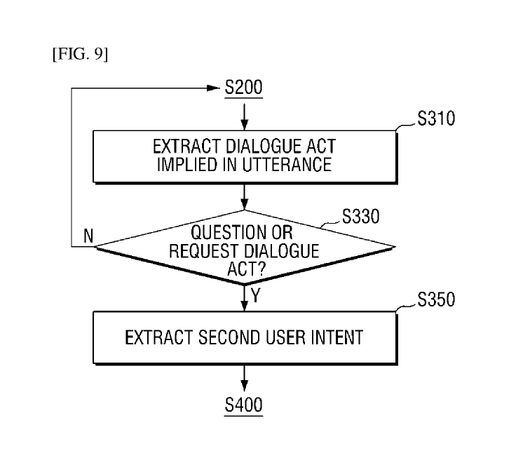

According to an embodiment of the present disclosure, the natural language processing unit 120 may perform dialogue act extraction, sentence feature extraction, and sentiment analysis using a predefined sentiment word dictionary in order to provide basic information used to perform functions of the user intent extraction unit 130 and the dialogue task switching determination unit 140. This will be described below in detail with reference to FIGS. 9 to 11.

The user intent extraction unit 130 extracts a user intent from the utterance data. To this end, the user intent extraction unit 130 may use a natural language processing result provided by the natural language processing unit 120.

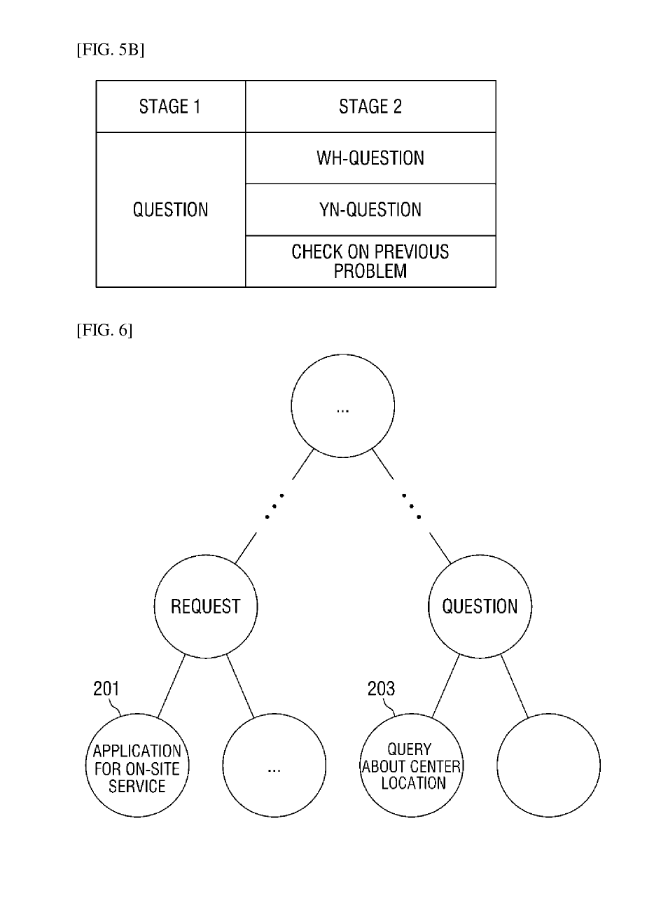

In some embodiments, the user intent extraction unit 130 may extract a user intent by using a keyword extracted by the natural language processing unit 120. In this case, a category for the user intent may be predefined. For example, the user intent may be predefined in the form of a hierarchical category or graph, as shown in FIG. 6. An example of the user intent may include an on-site service application 201, a center location query 203, or the like as described above.

In some embodiments, the user intent extraction unit 130 may use at least one clustering algorithm well known in the art in order to determine a user intent from the extracted keyword. For example, the user intent extraction unit 130 may cluster keywords indicating user intents and build a cluster corresponding to each user intent. Also, the user intent extraction unit 130 may determine a user intent included in a corresponding utterance by determining in which cluster or with which cluster a keyword extracted from the utterance is located or most associated using the clustering algorithm.

In some embodiments, the user intent extraction unit 130 may filter the utterance using dialogue act information provided by the natural language processing unit 120. In detail, the user intent extraction unit 130 may extract a user intent from a corresponding utterance only when a dialogue act implied in the utterance is a question dialogue act or a request dialogue act. In other words, before analyzing a detailed utterance intent of the user, the user intent extraction unit 130 may decrease the number of utterances from which user intents are to be extracted by using a dialogue act, which is a general utterance intent. Thus, it is possible to save computing costs required for the user intent extraction unit 130.

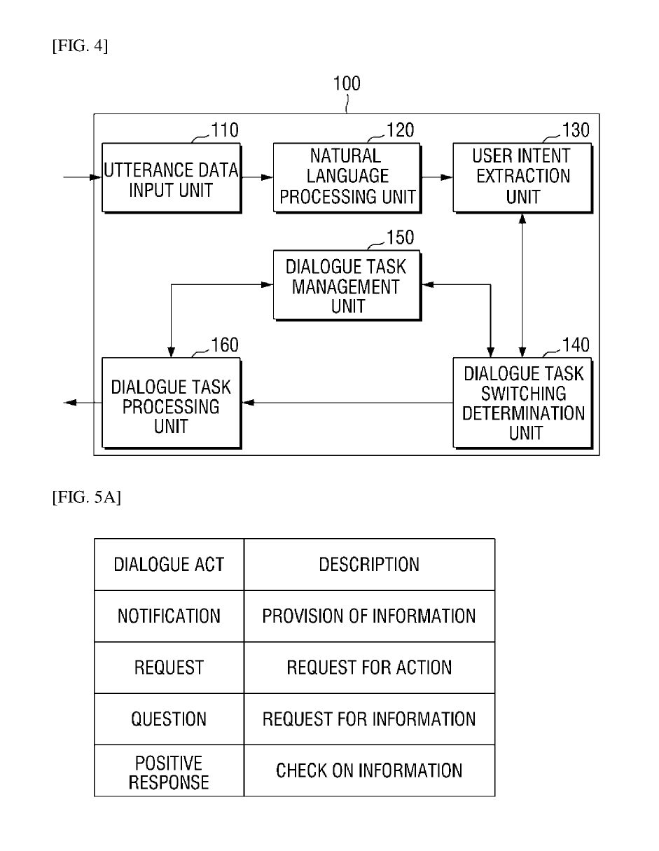

In the above embodiment, the type of dialogue act may be defined, for example, as shown in FIG. 5A. Referring to FIG. 5A, the type of dialogue act may include, but is not limited to, a request dialogue act requesting processing of an action, a notification dialogue act providing information, a question dialogue act requesting information, and the like. However, there may be various dialogue act classification methods.

Depending on the embodiment, also, the question dialogue act may be segmented into a first question dialogue act for requesting general information about a specific question (e.g., WH-question dialogue act), a second dialogue act for requesting only positive (yes) or negative (no) information (e.g., YN-question dialogue act), a third dialogue act for requesting confirmation of previous questions, and the like.

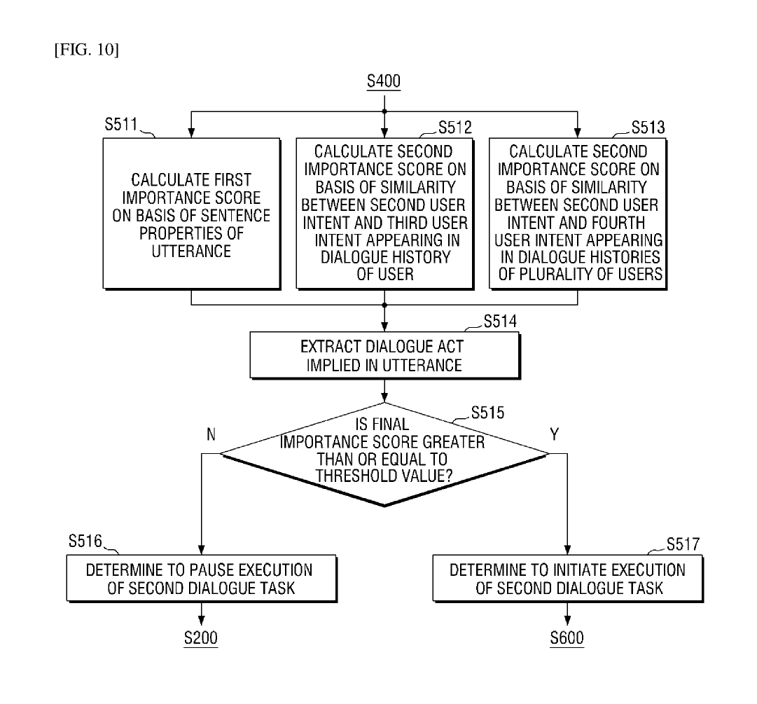

When a second user intent is detected from the input utterance during a first dialogue task corresponding to a first user intent, the dialogue task switching determination unit 140 may determine whether to initiate execution of the second dialogue task or to continue to execute the first dialogue task. The dialogue task switching determination unit 140 will be described below in detail with reference to FIGS. 10 to 15.

The dialogue task management unit 150 may perform overall dialogue task management. For example, when the dialogue task switching determination unit 140 determines to switch the current dialogue task from the first dialogue task to the second dialogue task, the dialogue task management unit 150 stores management information for the first dialogue task. In this case, the management information may include, for example, a task execution status (e.g., pause, termination, etc.), a task execution pause time, etc.

Also, when the second dialogue task is terminated, the dialogue task management unit 150 may resume the first dialogue task by using the stored management information.

The dialogue task processing unit 160 may process each dialogue task. For example, the dialogue task processing unit 160 generates an appropriate response sentence in order to accomplish a user intent which is the purpose of each dialogue task. In order to generate the response sentence, the dialogue task processing unit 160 may use a pre-built dialogue model. Here, the dialogue model may include, for example, a slot-filling-based dialogue frame, a finite-state-management-based dialogue model, etc.

For example, when the dialogue model is the slot-filling-based dialogue frame, the dialogue task processing unit 160 may generate an appropriate response sentence in order to fill a dialogue frame slot of the corresponding dialogue task. This is obvious to those skilled in the art, and thus a detailed description thereof will be omitted.

A dialogue history management unit (not shown) manages a user's dialogue history. The dialogue history management unit (not shown) may classify and manage the dialogue history according to a schematic criterion. For example, the dialogue history management unit (not shown) may manage a dialogue history by user, date, user's location, or the like, or may manage a dialogue history on the basis of demographic information (e.g., age group, gender, etc.) of users.

Also, the dialogue history management unit (not shown) may provide a variety of statistical information on the basis of the dialogue history. For example, the dialogue history management unit (not shown) may provide information such as a user intent appearing in the statistical information more than a predetermined number of times, a question including the user intent (e.g., a frequently asked question), and the like.

The elements of FIG. 4 that have been described may indicate software elements or hardware elements such as a field programmable gate array (FPGA) or an application-specific integrated circuit (ASIC). However, the elements are not limited to software or hardware elements, but may be configured to be in a storage medium which may be addressed and also may be configured to run one or more processors. The functions provided in the foregoing elements may be implemented by sub-elements into which the elements are segmented, and may be implemented by one element for performing a specific function by combining the plurality of elements.

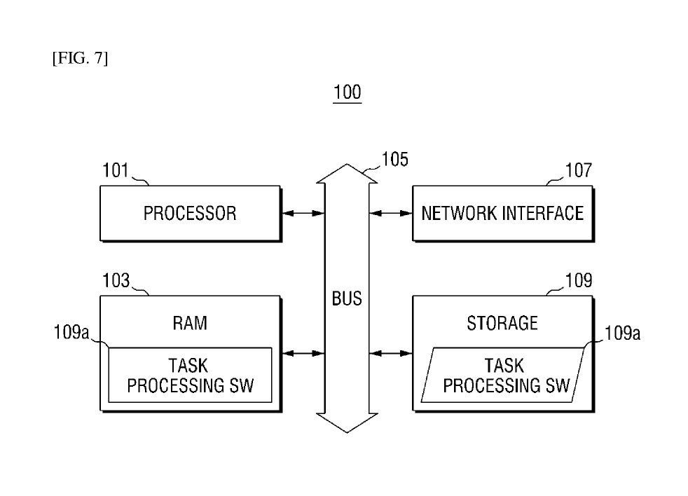

FIG. 7 is a hardware block diagram of the task processing apparatus 100 according to still another embodiment of the present disclosure.

Referring to FIG. 7, the task processing apparatus 100 may include one or more processors 101, a bus 105, a network interface 107, a memory 103 from which a computer program to be executed by the processors 101 is loaded, and a storage 109 configured to store task processing software 109a. However, only elements related to the embodiment of the present disclosure are shown in FIG. 7. Accordingly, it is to be understood by those skilled in the art that general-purpose elements other than the elements shown in FIG. 7 may be further included.

The processor 101 controls overall operation of the elements of the task processing apparatus 100. The processor 101 may include a central processing unit (CPU), a micro processor unit (MPU), a micro controller unit (MCU), a graphic processing unit (GPU), or any processors well known in the art. Further, the processor 101 may perform an operation for at least one application or program to implement the task processing method according to the embodiments of the present disclosure. The task processing apparatus 100 may include one or more processors.

The memory 103 may store various kinds of data, commands, and/or information. The memory 103 may load one or more programs 109a from the storage 109 to implement the task processing method according to embodiments of the present disclosure. In FIG. 7, a random access memory (RAM) is shown as an example of the memory 103.

The bus 105 provides a communication function between the elements of the task processing apparatus 100. The bus 105 may be implemented as various buses such as an address bus, a data bus, and a control bus.

The network interface 107 supports wired/wireless Internet communication of the task processing apparatus 100. Also, the network interface 107 may support various communication methods in addition to Internet communication. To this end, the network interface 107 may include a communication module well known in the art.

The storage 109 may non-temporarily store the one or more programs 109a. In FIG. 7, task processing software 109a is shown as an example of the one or more programs 109a.

The storage 109 may include a nonvolatile memory such as a read only memory (ROM), an erasable programmable ROM (EPROM), an electrically erasable programmable ROM (EEPROM), a flash memory, etc.; a hard disk drive; a detachable disk drive; or any computer-readable recording medium well known in the art.

The task processing software 109a may perform a task processing method according to an embodiment of the present disclosure.

In detail, the task processing software 109a is loaded into the memory 103 and is configured to, while a first dialogue task indicating a dialogue processing process for a first user intent is performed, execute an operation of detecting a second user intent different from the first user intent from a user's utterance, an operation of determining whether to execute a second dialogue task indicating a dialogue processing process for the second user intent in response to the detection of the second user intent, and an operation of generating a response sentence for the utterance in response to the determination of the execution of the second dialogue task by using the one or more processors 101.

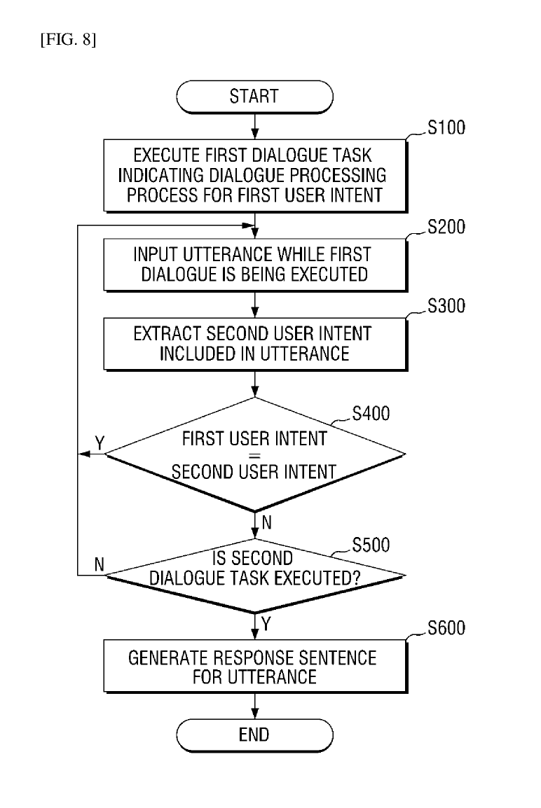

The configuration and operation of the task processing apparatus 100 according to an embodiment of the present disclosure have been described with reference to FIGS. 4 and 7. Subsequently, a task processing method according to still another embodiment of the present disclosure will be described in detail with reference to FIGS. 8 to 15.

The steps of the task processing method according to an embodiment of the present disclosure, which will be described below, may be performed by a computing apparatus. For example, the computing apparatus may be the task processing apparatus 100. For convenience of description, however, an operating entity of each of the steps included in the task processing method may be omitted. Also, since the task processing software 109a is executed by the processor 101, each step of the task processing method may be an operation performed by the task processing apparatus 100.

FIG. 8 is a flowchart of the task processing method according to an embodiment of the present disclosure. However, this is merely an example embodiment for achieving an object of the present disclosure, and it will be appreciated that some steps may be included or excluded if necessary.

Referring to FIG. 8, the task processing apparatus 100 executes a first dialogue task indicating a dialogue processing process for a first user intent (S100) and receives an utterance during the execution of the first dialogue task (S200).

Then, the task processing apparatus 100 extracts a second user intent from the utterance (S300). In this case, any method may be used as a method of extracting the second user intent.

In some embodiments, a dialogue act analysis may be performed before the second user intent is extracted. For example, as shown in FIG. 9, the task processing apparatus 100 may extract a dialogue act implied in the utterance (S310), determine whether the extracted dialogue act is a question dialogue act or a request dialogue act (S330), and extract a second user intent included in the utterance only when the extracted dialogue act is a question dialogue act or a request act (S350).

Subsequently, the task processing apparatus 100 determines whether the extracted second user intent is different from the first user intent (S400).

In some embodiments, the task processing apparatus 100 may perform step S400 by calculating a similarity between the second user intent and the first user intent and determining whether the similarity is less than or equal to a predetermined threshold value. For example, when the user intents are built as clusters, the similarity may be determined based on a distance between the centroids of the clusters. As another example, when the user intent is set to a graph-based data structure as shown in FIG. 6, the user intent may be determined based on a distance between a first node corresponding to the first user intent and a second node corresponding to the second user intent.

When a result of the determination in step S400 is that the user intents are different from each other, the task processing apparatus 100 determines whether to initiate execution of a second dialogue task indicating a dialogue processing process for the second user intent (S500). The step will be described below in detail with reference to FIGS. 10 to 15.

When the initiation of the execution is determined in step S500, the task processing apparatus 100 initiates execution of the second dialogue task by generating a response sentence for the utterance in response to the determination of the initiation of the execution (S600). In step S600, a dialogue model in which dialogue details, orders and the like are defined may be used to generate the response sentence, and an example of the dialogue model may be referred to in FIGS. 14 and 15.

The task processing method according to an embodiment of the present disclosure has been described with reference to FIGS. 8 and 9. The dialogue task switching determination method performed in step S500 shown in FIG. 8 will be described in detail below with reference to FIGS. 10 to 15.

FIG. 10 shows a first flowchart of the dialogue task switching determination method.

Referring to FIG. 10, the task processing apparatus 100 may determine whether to initiate execution of a second dialogue task on the basis of an importance score of an utterance itself.

Specifically, the task processing apparatus 100 calculates a first importance score on the basis of sentence features(properties) of the utterance (S511). Here, the sentence features may include, for example, the number of nouns, the number of words recognized through named entity recognition, etc. The named entity recognition may be performed using at least one named entity recognition algorithm well known in the art.

In step S511, the task processing apparatus 100 may calculate the first importance score through, for example, a weighted sum based on a sentence feature importance score and a sentence feature weight and may determine the sentence feature importance score to be high, for example, as the number increases. The sentence feature weight may be a predetermined fixed value or a value that varies depending on the situation.

Also, the task processing apparatus 100 may calculate a second importance score on the basis of a similarity between a second user intent and a third user intent appearing in a user's dialogue history. Here, the third user intent may refer to a user intent determined based on a statistical result for the user's dialogue history. For example, the third user intent may include a user intent appearing in the dialogue history of the corresponding user more than a predetermined number of times.

Also, the task processing apparatus 100 may calculate a third importance score on the basis of a similarity between a second user intent and a fourth user intent appearing in dialogue histories of a plurality of users. Here, the plurality of users may include a user who made an utterance and may have a concept including another user who has executed a dialogue task with the task processing apparatus 100. Here, the fourth user intent may refer to a user intent determined based on a statistical result for the dialogue histories of the plurality of users. For example, the fourth user intent may include a user intent appearing in the dialogue histories of the plurality of users more than a predetermined number of times.

In steps S512 and 513, the similarity may be calculated in any way such as the above-described cluster similarity, graph-distance-based similarity, etc.

Subsequently, the task processing apparatus 100 may calculate a final importance score on the basis of the first importance score, the second importance score, and the third importance score. For example, the task processing apparatus may calculate the final importance score through a weighted sum of the first to third importance scores (S514). Here, each weight used for the weighted sum may be a predetermined fixed value or a value that varies depending on the situation.

Subsequently, the task processing apparatus 100 may determine whether the final importance score is greater than or equal to a predetermined threshold value (S515) and may determine to initiate execution of the second dialogue task (S517). Otherwise, the task processing apparatus 100 may determine to pause or stop the execution of the second dialogue task.

As shown in FIG. 10, there is no order between the steps (S511 to S513), and the steps may be performed sequentially or in parallel depending on the embodiment. Also, in some embodiments, the final importance score may be calculated only using at least one of the first importance score and the third importance score.

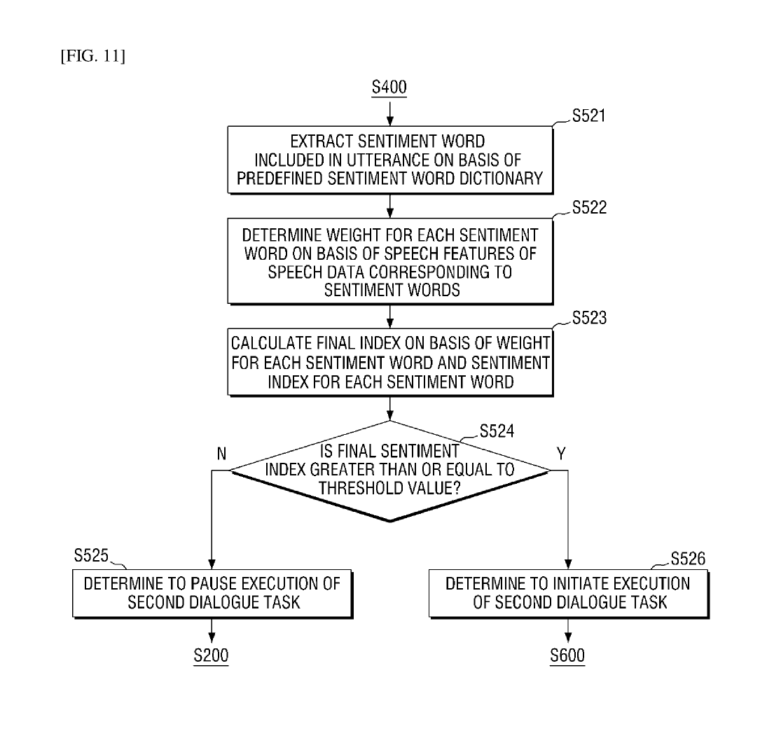

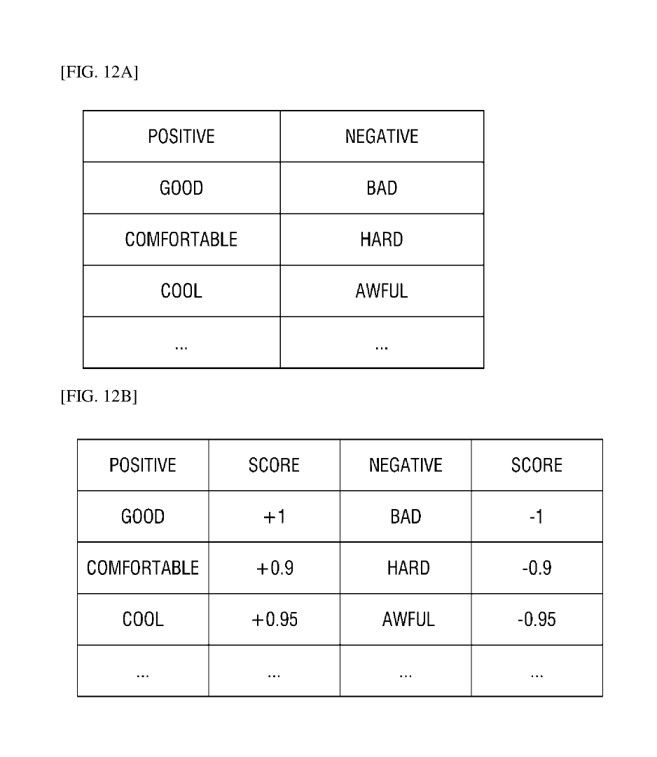

Subsequently, a second flowchart of the dialogue task switching determination method will be described with reference to FIGS. 11 to 12B.

Referring to FIG. 11, the task processing apparatus 100 may determine whether to initiate execution of a second dialogue task on the basis of a sentiment index of an utterance itself. This is because a current sentiment state of a user who is receiving consultation is closely related to customer satisfaction in an intelligent ARS system.

Specifically, the task processing apparatus 100 extracts a sentiment word included in an utterance on the basis of a predefined sentiment word dictionary in order to grasp a user's current sentiment state from the utterance (S521). The sentiment word dictionary may include a positive word dictionary and a negative word dictionary as shown in FIG. 12A and may include sentiment index information for sentiment words as shown in FIG. 12B.

Subsequently, the task processing apparatus 100 may calculate a final sentiment index indicating a user's sentiment state by using a weighted sum of sentiment indices of the extracted sentiment words. Here, among sentiment word weights used for the weighted sum, high weights may be assigned to sentiment indices of sentiment words associated with negativeness. This is because an utterance needs to be processed more quickly as a user becomes closer to a negative sentiment state.

According to an embodiment of the present disclosure, when speech data corresponding to the utterance is input, the user's sentiment state may be accurately grasped using the speech data.

Specifically, in this embodiment, the task processing apparatus 100 may determine the sentiment word weights used to calculate the final sentiment index on the basis of speech features of a speech data part corresponding to each of the sentiment words (S522). Here, the speech features may include, for example, features such as tone, level, speed, and volume. As a detailed example, when speech features, such as loud voice, high tone, or high speed, of a first speech data part corresponding to a first sentiment word are extracted, a high sentiment word weight may be assigned to a sentiment index of the first sentiment word. That is, when speech features indicating an exaggerated sentiment state or a negative sentiment state appear in specific speech data, a high index may be assigned to a sentiment word sentiment index corresponding to the speech data part.

Subsequently, the task processing apparatus 100 may calculate a final sentiment index using a weighted sum of sentiment word weights and sentiment word sentiment indices (S523) and may determine to initiate execution of the second dialogue task when the final sentiment index is greater than or equal to a threshold value (S524, S525).

Depending on the embodiment, a machine learning model may be used to predict a user's sentiment state from the speech features. In this case, the sentiment word weights may be determined on the basis of the user's sentiment state predicted through the machine learning model.

Alternatively, depending on the embodiment, the user's sentiment state appearing throughout the utterance may be predicted using the machine learning model. In this case, when the user's current sentiment state revealed in the utterance satisfies a predetermined condition (e.g., when a negative sentiment appears strongly), the initiation of the execution of the second dialogue task may be immediately determined.

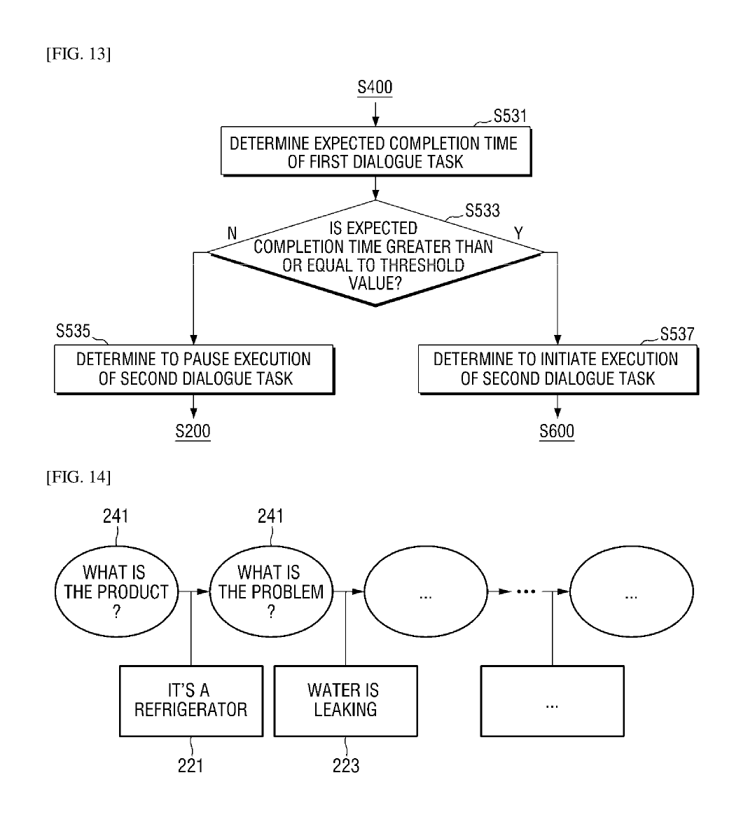

Subsequently, a third flowchart of the dialogue task switching determination method will be described with reference to FIGS. 13 to 15.

Referring to FIG. 13, the task processing apparatus 100 may determine whether to initiate execution of a second dialogue task on the basis of an expected completion time of a first dialogue task. This is because it is more efficient to complete the first dialogue task and initiate execution of the second dialogue task when an execution completion time of the first dialogue task is approaching.

Specifically, the task processing apparatus 100 determines an expected completion time of the first dialogue task (S531). Here, a method of determining the expected completion time of the first dialogue task may vary, for example, depending on a dialogue model for the first dialogue task.

For example, when the first dialogue task is executed on the basis of a graph-based dialogue model (e.g., a finite-state-management-based dialogue model), the expected completion time of the first dialogue task may be determined based on a distance between a first node (e.g., 211, 213, 221, and 223) indicating a current execution time of the first dialogue task and a second node (e.g., the last node) indicating a processing completion time with respect to the graph-based dialogue model.

As another example, when the first dialogue task is executed on the basis of a slot-filling-based dialogue frame as shown in FIG. 15, the expected completion time of the first dialogue task may be determined on the basis of the number of empty slots of the dialogue frame.

Subsequently, when the expected completion time of the first dialogue task, which is determined in step S531, is greater than or equal to a predetermined threshold value, the task processing apparatus 100 may determine to initiate execution of the second dialogue task (S533 and S537). Otherwise, if the expected completion time is almost approaching, the task processing apparatus 100 may pause or stop the execution of the second dialogue task and may quickly process the first dialogue task (S535).

According to an embodiment of the present disclosure, the task processing apparatus 100 may determine to initiate the execution of the second dialogue task on the basis of an expected completion time of the second dialogue task. This is because it is more efficient to process the second dialogue task quickly and to continue the first dialogue task when the second dialogue task is a task that may be terminated quickly.

In detail, when the second dialogue task is executed on the basis of the slot-filling-based dialogue frame, the task processing apparatus 100 may fill a slot of a dialogue frame for the second dialogue task on the basis of the utterance and dialogue information used to process the first dialogue task and may determine an expected completion time of the second dialogue task on the basis of the number of empty slots of the dialogue frame. Also, when the expected completion time of the second dialogue task is less than or equal to a predetermined threshold value, the task processing apparatus 100 may determine to initiate execution of the second dialogue task.

Also, according to an embodiment of the present disclosure, the task processing apparatus 100 may compare the expected completion time of the first dialogue task and the expected completion time of the second dialogue task and may execute a dialogue task having a shorter expected completion time so as to quickly finish. For example, when the expected completion time of the second dialogue task is shorter, the task processing apparatus 100 may determine to initiate execution of the second dialogue task.

Also, according to an embodiment of the present disclosure, the task processing apparatus 100 may determine whether to initiate execution of the second dialogue task on the basis of a dialogue act implied in the utterance. For example, when the dialogue act of the utterance is a question dialogue act for requesting a positive (yes) or negative (no) response (e.g., YN-question dialogue act), the dialogue task may be quickly terminated. Thus, the task processing apparatus 100 may determine to initiate execution of the second dialogue task. Also, the task processing apparatus 100 may resume the execution of the first dialogue task directly after generating a response sentence of the utterance.

Also, according to an embodiment of the present disclosure, the task processing apparatus 100 may determine to initiate the execution of the second dialogue task on the basis of a progress status of the first dialogue task. For example, when the first dialogue task is executed on the basis of a graph-based dialogue model, the task processing apparatus 100 may calculate a distance between a first node indicating a start node of the first dialogue task and a second node indicating a current execution point of the first dialogue task with respect to the graph-based dialogue model and may determine to initiate execution of the second dialogue task only when the calculated distance is less than or equal to a predetermined threshold value.

According to some embodiments of the present disclosure, in order to accurately grasp a user intent, the task processing apparatus 100 may generate and provide a response sentence for asking a query about determination of whether to switch the dialogue task.

For example, while a dialogue task corresponding to a first user intent is being executed, a second user intent different from the first user intent may be detected from the utterance. In this case, the task processing apparatus 100 may ask a query for understanding a user intent. In detail, the task processing apparatus 100 may calculate a similarity between the first user intent and the second user intent and may generate and provide a query sentence about whether to initiate execution of the second dialogue task when the similarity is less than or equal to a predetermined threshold value. Also, the task processing apparatus 100 may determine to initiate execution of the second dialogue task on the basis of an utterance input in response to the query sentence.

As another example, in the flowcharts shown in FIGS. 8, 10, 11, and 13, the task processing apparatus may generate and provide a query sentence about whether to initiate execution of the second dialogue task before or when the task processing apparatus 100 pauses the execution of the second dialogue task (S500, S516, S525, and S535).

As still another example, the task processing apparatus 100 may automatically determine to pause the execution of the second dialogue task when the determination index (e.g., the final importance score, the final sentiment index, or the expected completion time) used in the flowcharts shown in FIGS. 10, 11, and 13 are less than a first threshold value, may generate and provide the query sentence when the determination index is between the first threshold value and a second threshold value (in this case, the second threshold value is set to be greater than the first threshold value), and may determine to initiate execution of the second dialogue task when the determination index is greater than or equal to the second threshold value.

According to some embodiments of the present disclosure, the task processing apparatus 100 may calculate importance scores of utterances using a first Bayes model based on machine learning and may determine whether to initiate execution of the second dialogue task on the basis of a result of comparison between the calculated importance scores. Here, the first Bayes model may be, but is not limited to, a naive Bayes model. Also, the first Bayes model may be a model that is learned based on a dialogue history of a user who made an utterance.

In detail, the first Bayes model may be established by learning the user's dialogue history in which a certain importance score is tagged for each utterance. Features used for learning may be, for example, words and nouns included in the utterance, words recognized through the named entity recognition, and the like. For learning, a maximum likelihood estimation (MLE) method may be used, but a maximum a posteriori (MAP) method may also be used when a prior probability is present. When the first Bayes model is established, Bayes probabilities of a first utterance which is associated with the first dialogue task and a second utterance from which the second user intent is detected may be calculated using features included in the utterances, and importance scores of the utterances may be calculated using the Bayes probabilities. For example, it is assumed that importance scores of the first utterance and the second utterance are calculated. Under this assumption, by using the first Bayes model, a first-prime Bayes probability indicating an importance score predicted for the first utterance may be calculated, and a first-double-prime Bayes probability indicating an importance score predicted for the second utterance may be calculated. Then, the importance scores of the first utterance and the second utterance may be evaluated using a relative ratio (e.g., a likelihood ratio) between the first-prime Bayes probability and the first-double-prime Bayes probability.

According to some embodiments of the present disclosure, the importance scores of the utterances may be calculated using a second Bayes model based on machine learning. Here, the second Bayes model may be a model that is learned based on dialogue histories of a plurality of users (e.g., a total number of users who use an intelligent ARS service). The second Bayes model may also be, for example, a naive Bayes model, but the present disclosure is not limited thereto. The method of calculating the importance scores of the utterances using the second Bayes model is similar to that using the first Bayes model, and thus a detailed description thereof will be omitted.

According to some embodiments of the present disclosure, both of the first Bayes model and the second Bayes model may be used to calculate the importance scores of the utterances. For example, it is assumed that the importance scores of the first utterance, which is associated with the first dialogue task, and the second utterance, from which the second user intent is detected, are calculated. Under this assumption, by using the first Bayes model, a first-prime Bayes probability indicating an importance score predicted for the first utterance may be calculated, and a first-double-prime Bayes probability indicating an importance score predicted for the second utterance may be calculated. Also, by using the second Bayes model, a second-prime Bayes probability of the first utterance may be calculated, and a second-double-prime Bayes probability of the second utterance may be calculated. Then, a first-prime importance score of the first utterance and a first-double-prime importance score of the second utterance may be determined using a relative ratio (e.g., a likelihood ratio) between the first-prime Bayes probability and the first-double-prime Bayer probability. Similarly, a second-prime importance score of the first utterance and a second-double-prime importance score of the second utterance may be determined using a relative ratio (e.g., a likelihood ratio) between the second-prime Bayes probability and the second-double-prime Bayer probability. Finally, a final importance score of the first utterance may be determined through a weighted sum of the first-prime importance score and the second-prime importance score, or the like, and a final importance score of the second utterance may be determined through a weighted sum of the first-double-prime importance score and the second-double-prime importance score, or the like. Then, the task processing apparatus 100 may determine whether to initiate execution of the second dialogue task for processing the second user intent on the basis of a result of comparison between the final importance score of the first utterance and the final importance score of the second utterance. For example, when the final importance score of the second utterance is higher than the final importance score of the first utterance, or when a difference between the scores satisfies a predetermined condition, for example, being greater than or equal to a predetermined threshold value, the task processing apparatus 100 may determine to initiate execution of the second dialogue task.

The task processing method according to an embodiment of the present disclosure has been described with reference to FIGS. 8 and 15. According to the above method, when a second user intent different from a first user intent is detected from a user's utterance while a first dialogue task for the first user intent is being executed, it is possible to automatically determine whether to initiate execution of a second dialogue task for the second user intent in consideration of a dialogue situation, the user's utterance intent, etc. Thus, the intelligent agent to which the present disclosure is applied can cope with a sudden change in the user intent and conduct a smooth dialogue without intervention of a person such as a call counselor.

Also, when the present disclosure is applied to an intelligent ARS system that provides customer service, it is possible to grasp a customer's intent to conduct a smooth dialogue, thereby improving customer satisfaction.

Also, by using the intelligent ARS system to which the present disclosure is applied, it is possible to minimize intervention of a person such as a call counselor and thus significantly save human costs required to operate the system.

According to the present disclosure, when a second user intent different from a first user intent is detected from a user's utterance while a first dialogue task for the first user intent is being executed, it is possible to automatically determine whether to initiate execution of a second dialogue task for the second user intent in consideration of a dialogue situation, the user's utterance intent, etc. Thus, the intelligent agent to which the present disclosure is applied can cope with a sudden change in the user intent and conduct a smooth dialogue without intervention of a person such as a call counselor.

Also, when the present disclosure is applied to an intelligent ARS system that provides customer service, it is possible to grasp a customer's intent to conduct a smooth dialogue, thereby improving customer satisfaction.

Also, by using the intelligent ARS system to which the present disclosure is applied, it is possible to minimize intervention of a person such as a call counselor and thus significantly save human costs required to operate the system.

In addition, according to the present disclosure, it is possible to accurately grasp a user's topic switching intent from an utterance, including the second user intent, according to a rational criteria such as importance of the utterance itself, a dialogue history of the user, a result of emotional analysis, etc.

Also, according to the present disclosure, it is possible to determine to switch a dialogue task on the basis of expected completion time(s) of the first dialogue task and/or the second dialogue task. That is, even when a dialogue task is almost completed, it is possible to quickly process a corresponding dialogue and execute the next dialogue task, thereby performing efficient dialogue task processing.

The effects of the present disclosure are not limited to the aforementioned effects, and other effects which are not mentioned herein can be clearly understood by those skilled in the art from the following description.

The concepts of the disclosure described above with reference to FIGS. 1 to 15 can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present disclosure has been particularly illustrated and described with reference to exemplary embodiments thereof, it will be understood by those of ordinary skill in the art that various changes in form and detail may be made therein without departing from the spirit and scope of the present disclosure as defined by the following claims. The exemplary embodiments should be considered in a descriptive sense only and not for purposes of limitation.

What is claimed is:

1. A task processing method performed by a task processing apparatus, the task processing method comprising:
detecting a second user intent different from a first user intent based on an utterance of a user while a first dialogue task comprising a first dialogue processing process corresponding to the first user intent is being executed;
determining whether to initiate execution of a second dialogue task comprising a second dialogue processing process corresponding to the second user intent based on the detection of the second user intent; and
generating a response sentence responding to the utterance based on the determination of the initiation of the execution of the second dialogue task.

2. The task processing method of claim 1, wherein the detecting of the second user intent different from the first user intent comprises:
receiving the utterance;
extracting a dialogue act based on the utterance by a dialogue act analysis;
extracting the second user intent from the utterance based on the extracted dialogue act being a question dialogue act or a request dialogue act; and
comparing the first user intent and the second user intent.

3. The task processing method of claim 1,
wherein the determining of whether to initiate execution of the second dialogue task comprises:
extracting a dialogue act based on the utterance by a dialogue act analysis; and
determining to initiate execution of the second dialogue task based on the extracted dialogue act being a question dialogue act that requests a positive response or a negative response, and
wherein the task processing method further comprises resuming execution of the first dialogue task after the generating of the response sentence.

4. The task processing method of claim 1, wherein the determining of whether to initiate execution of the second dialogue task comprises:
calculating an importance score of the utterance based on a sentence feature of the utterance; and
determining to initiate execution of the second dialogue task based on the importance score being greater than or equal to a threshold value.

5. The task processing method of claim 4, wherein the sentence feature comprises the number of nouns and the number of words recognized by named entity recognition.

6. The task processing method of claim 1, wherein the determining of whether to initiate execution of the second dialogue task comprises determining whether to initiate execution of the second dialogue task based on a similarity between the second user intent and a third user intent included in statistical information, which is calculated based on a dialogue history of a user who made the utterance, more than a predetermined number of times.

7. The task processing method of claim 1, wherein the determining of whether to initiate execution of the second dialogue task comprises determining whether to execute the second dialogue task based on a similarity between the second user intent and a third user intent included in statistical information, which is determined based on dialogue histories of a plurality of users, more than a predetermined number of times.

8. The task processing method of claim 1, wherein the determining of whether to initiate execution of the second dialogue task comprises:
performing sentiment analysis based on sentiment words included in the utterance; and
determining whether to initiate execution of the second dialogue task based on a result of the sentiment analysis.

9. The task processing method of claim 8, further comprising receiving speech data corresponding to the utterance,
wherein the performing of sentiment analysis comprises performing the sentiment analysis based on at least one speech feature included in the speech data.

10. The task processing method of claim 9,
wherein the performing of sentiment analysis based on the at least one speech feature included in the speech data comprises:
extracting sentiment words included in the utterance based on a predefined sentiment dictionary; and
calculating a result of the sentiment analysis based on a weighted sum of sentiment indices corresponding to the extracted sentiment words, respectively, and
wherein a weight for each sentiment word used in the weighted sum is determined based on the at least one speech feature of a speech data part corresponding to the extracted sentiment words.

11. The task processing method of claim 1, wherein the determining of whether to initiate execution of the second dialogue task comprises determining whether to initiate execution of the second dialogue task based on an expected completion time of the first dialogue task.

12. The task processing method of claim 11,
wherein the first dialogue task is executed based on a slot-filling-based dialogue frame, and
wherein the expected completion time of the first dialogue task is determined based on a number of empty slots included in the dialogue frame.

13. The task processing method of claim 11,
wherein the first dialogue task is executed based on a graph-based dialogue model, and
wherein the expected completion time of the first dialogue task is determined based on a distance between a first node corresponding to a current execution point of the first dialogue task and a second node corresponding to a processing completion point of the first dialogue task with respect to the graph-based dialogue model.

14. The task processing method of claim 1,
wherein the first dialogue task is executed based on a graph-based dialogue model, and
wherein the determining of whether to initiate execution of the second dialogue task comprises determining whether to initiate execution of the second dialogue task based on a distance between a first node corresponding to a start point of the first dialogue task and a second node corresponding to a current execution point of the first dialogue task with respect to the graph-based dialogue model.

15. The task processing method of claim 1, wherein the determining of whether to initiate execution of the second dialogue task comprises determining whether to initiate execution of the second dialogue task based on an expected completion time of the second dialogue task.

16. The task processing method of claim 15,
wherein the second dialogue task is executed based on a slot-filling-based dialogue frame, and
wherein the determining of whether to initiate execution of the second dialogue task based on the expected completion time of the second dialogue task comprises:
filling a slot of a dialogue frame for the second dialogue task based on the utterance and dialogue information corresponding to the first dialogue task; and
determining whether to initiate execution of the second dialogue task based on the expected completion time of the second dialogue task determined based on a number of empty slots included in the dialogue frame.

17. The task processing method of claim 1, wherein the determining of whether to initiate execution of the second dialogue task comprises:
comparing an expected completion time of the first dialogue task and an expected completion time of the second dialogue task; and
determining whether to initiate execution of the second dialogue task based on a result of the comparison.

18. The task processing method of claim 1, wherein the determining of whether to initiate execution of the second dialogue task comprises:
determining a similarity between the first user intent and the second user intent;
generating and providing a query sentence about whether to initiate execution of the second dialogue task; and
determining whether to initiate execution of the second dialogue task based on an utterance input responding to the query sentence.

19. The task processing method of claim 1,
wherein the determining of whether to initiate execution of the second dialogue task comprises:
calculating importance scores of a first utterance of a user corresponding to the first dialogue task and a second utterance corresponding to the second intent; and
determining whether to initiate execution of the second dialogue task based on a result of a comparison between the calculated importance scores,
wherein the calculating of the importance scores comprises:
calculating a first-prime Bayes probability corresponding to an importance score predicted for the first utterance and calculating a first-double-prime Bayes probability corresponding to an importance score predicted for the second utterance by using a first Bayes model based on machine learning; and
calculating the importance scores of the first utterance and the second utterance based on the first-prime Bayes probability and the first-double-prime Bayes probability, and
wherein the first Bayes model is a model that is machine-learned based on a dialogue history of the user.

20. The task processing method of claim 19,
wherein the calculating of the importance scores of the first utterance and the second utterance based on the first-prime Bayes probability and the first-double-prime Bayes probability comprises:
calculating a second-prime Bayes probability of the first utterance and a second-double-prime Bayes probability of the second utterance by using a second Bayes model based on machine learning; and
evaluating the importance scores of the first utterance and the second utterance by using the second-prime Bayes probability and the second-double-prime Bayes probability, and
wherein the second Bayes model is a model that is machine-learned based on dialogue histories of a plurality of users.
